(19) United States
(12) Patent Application Publication
(10) Pub. No.: US 2015/0235049 A1
(43) Pub. Date: Aug. 20, 2015

(54) Maintaining Data Privacy in a Shared Data Storage System

(71) Applicant: International Business Machines Corporation, Armonk, NY (US)

(72) Inventors: Simona Cohen, Haifa (IL); Alan Hartman, Haifa (IL); John Michael Marberg, Haifa (IL); Micha Gideon Moffie, Zichron Yaakov (IL); Kenneth Nagin, Mitzpeh Hoshiya (IL)

(73) Assignee: International Business Machines Corporation, Armonk, NY (US)

(21) Appl. No.: 14/184,718

(22) Filed: Feb. 20, 2014

(51) Int. Cl. G06F 21/62

(52) U.S. Cl. CPC G06F 21/6245; G06F 21/6254

(57) ABSTRACT

Machines, systems and methods for sanitizing data are provided. The method comprises determining whether a data request is submitted by an authorized user, in response to receiving the data request, wherein the data request is for accessing first data stored on a data storage system; in response to determining that the data request is submitted by an authorized user, analyzing data access history by the user to the data storage system; in response to determining that the user has previously accessed data on the data storage system that in light of the first data reveal confidential information which the user is not authorized to access, restricting user's access to the confidential information.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to data storage and data privacy and, more particularly, to a system and method for maintaining data security and privacy in a shared data storage environment.

### BACKGROUND

Data stored in network storage systems may include personal identifiable information (PII) such as a person's name, address, phone number, social security, date of birth, etc. This type of data is often considered as private and confidential and should be protected from access by unauthorized users. A certain group of users (e.g., doctors) may be allowed to view a patient's name, age and medical history, while another group of users (e.g., billing personnel) may be limited to view the patient's name, address and billing history, only.

In the above example, when patient records are being produced in response to a request, a software program may be used to sanitize the data by removing the PII from the records before the results are provided to the requesting party. Typically, the sanitizing software program is executed on a centralized server system that is remotely connected to the storage system on which the data is stored. The remote connection between the server system and the storage system is usually over a communications network.

Accordingly, each time the server system receives a request for data, the target data has to be first transferred from the storage system to the server. Once the data is transferred to the server, sanitizing software is applied to the data to remove the PII. Afterwards, the sanitized data is provided to the requestor.

Transferring unsanitized data to the server exposes the data to attack by a hacker. The hacker could intercept the data as it passes over the network between the storage system and the server. Also the hacker could break into the server system and retrieve the unsanitized data. In order to mitigate this vulnerability, it is desirable to secure the network connection between the storage system and the server and secure access to the server. Systems and methods that help maintain data privacy are desirable, preferably those that avoid or reduce the additional cost associated with securing the network and the server.

Further, the transfer of data from the storage system to the server and then to the requestor can consume network bandwidth and processing resources on the server, resulting in a bottleneck effect when sufficient resources are not available on the server to expediently service the incoming requests. Systems and methods are desirable that can help maintain data privacy and further reduce the transmission and processing overhead associated with accessing the data.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for sanitizing data is provided. The method comprises determining whether a data request is submitted by an authorized user, in response to receiving the data request, wherein the data request is for accessing first data stored on a data storage system; in response to determining that the data request is submitted by an authorized user, analyzing data access history by the user to the data storage system; in response to determining that the user has previously accessed data on the data storage system that in light of the first data reveal confidential information which the user is not authorized to access, restricting user's access to the confidential information.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary operating environment in accordance with one or more embodiments, wherein a storage system is implemented to service a plurality of data requests.

FIGS. 2 and 3 are exemplary flow diagrams of a method for sanitizing data in accordance with one embodiment.

FIGS. 4A and 4B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

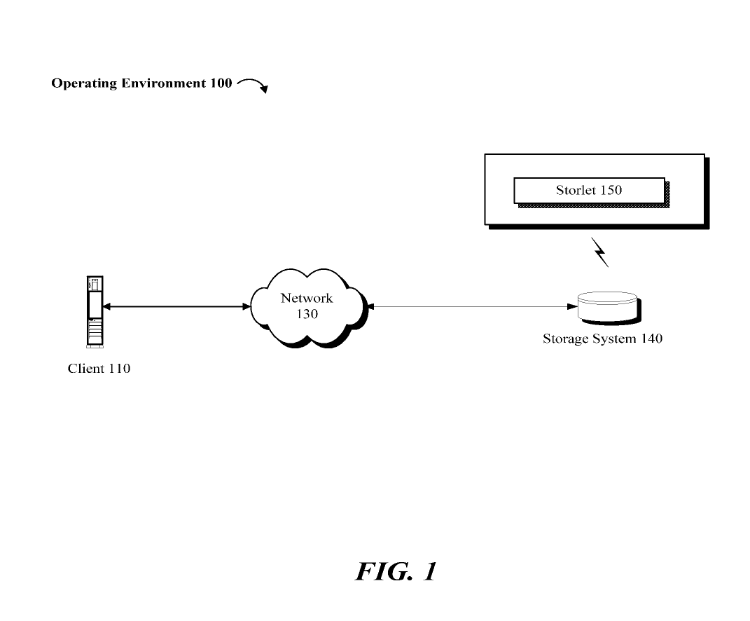

Referring to FIG. 1, an exemplary operating environment 100 is illustrated in which a client 110 is utilized by a user to submit data requests to access data stored on a storage system 140. Client 110 may be a computing system or machine (e.g., a personal computer) that communicates over network 130 with storage system 140. The storage system 140 is connected to network 130 for processing certain requests submitted by client 110. The operating environment 100 is implemented to ensure the maintenance of data privacy and data security for data communicated over network 130.

In accordance with one embodiment, storage system 140 may be used to authenticate user access to storage media in storage system 140. In one embodiment, the responsibility for sanitization of data may be placed on a security feature implemented on the storage system 140. In one example, a sanitizing mechanism hereafter referred to as a storlet 150 is executed on the storage system 140. A storlet is a computing architecture that allows data stored on the storage system 140 to be processed locally at the storage system 140, instead of the data having to be transferred to a centralized server system for analysis and processing.

By implementing the storlet architecture on the storage system 140, a request for accessing the target data may be submitted to the storlet 150 running on the storage system 140 for processing. Upon receiving the request, the storlet 150 determines the permissions associated with the submitted request and sanitizes the target data according to the authorization level associated with the received request, based on the corresponding access permissions and policies. For example, if the request is submitted by billing personnel to retrieve patient records, then the generated report may include patient's billing history, in addition to the patient's name and billing address. However, the storlet 150 would remove or hide data related to the person's age, specific medical history or other personal data, such as social security number, for example.

The security analysis and data sanitization process performed by the storlet 150 may be accomplished by way of de-identification or anonymization. De-identification is the process of hiding or removing PII's from a document or a data set. De-identification may be applied one document at a time. Methods for de-identification include removing the information completely, masking the information with special characters (e.g. ‘*’), etc. The anonymization process may be used to remove or modify (Quasi-) identifiers such as zip code, birth data and sex, which can be used to indirectly identify a person by linking with other sources of data. Anonymization aggregates, perturbs or generalizes the data so that some usefulness purpose is maintained.

In one embodiment, to further secure access to data stored on the storage server, the storlet 150 may be implemented to maintain an access history for data as the data is being requested or accessed by different users. Access history may be taken into account when anonymizing the subject data. For example, access history may indicate that on a certain date a particular user requested and received information about a particular group of patients, and that the provided data included information about an age group which at the time of production of the data was being treated for a certain illness. Since sanitized data may be linked to or mined to extract or deduce particular demographic, in one embodiment, data access history for a user may be analyzed to determine if the user may be able to conclude detailed personal information from the newly requested records and previously accessed records by way of cross checking the newly request data against the previous records.

In other words, if the history of data accessed by a user is not accounted for and the newly produced data is not de-identified or anonymized privacy may be breached. For example, it would be possible for the user to extract personal or sensitive information from a data collection if certain records are linked to or compared with other records to identify a cross-section of information that has been updated or hidden. For example, an earlier set of patient records may provide information about the age of a group of patients and some medical history of the patients. A new set of records for the same group of patients may provide the same type of age and medical history data. However, since a known amount of time has passed from the production of the earlier set of records, the age information for the patients has changed by the same exact amount, and if analyzed and cross-referenced, may reveal personal information that is identifiable for particular patients.

### EXAMPLE

Assume a set of patients for which the following records are produced. Specifically, the attributes age, zip and sex are anonymized such that there is never a tuple (age, zip and sex) that is indistinguishable from at least one other record (e.g. 2-anonymity):

| | | | |
|---|---|---|---|
| [60-64] | 02144 | Male | brain-infection |
| [60-64] | 02144 | Male | Blindness |
| [60-64] | 02144 | Male | Bowel-Twist |
| [60-64] | 02144 | Male | kidney-infection |
| [65-69] | 02139 | Female | Lung-cancer |
| [65-69] | 02139 | Female | breast-cancer |
| [65-69] | 02144 | Male | Appendicitis |
| [65-69] | 02144 | Male | Ulcer |

Assume 1 year has passed and a new set of anonymized records is generated:

| | | | |
|---|---|---|---|
| [60-64] | 02144 | Male | brain-infection |
| [60-64] | 02144 | Male | Blindness |
| [60-64] | 02144 | Male | Bowel-Twist |
| [65-69] | 02144 | Male | kidney-infection |
| [65-69] | 02139 | Female | Lung-cancer |
| [65-69] | 02139 | Female | breast-cancer |
| [65-69] | 02144 | Male | Appendicitis |
| [65-69] | 02144 | Male | Ulcer |

Notice that although the second set adheres to 2-anonymity, one can use the previous set and the knowledge that a single year has passed to reveal private information. Specifically for the record marked in bold—one can deduce the age of 65—providing potential identifiable information to the data receiver.

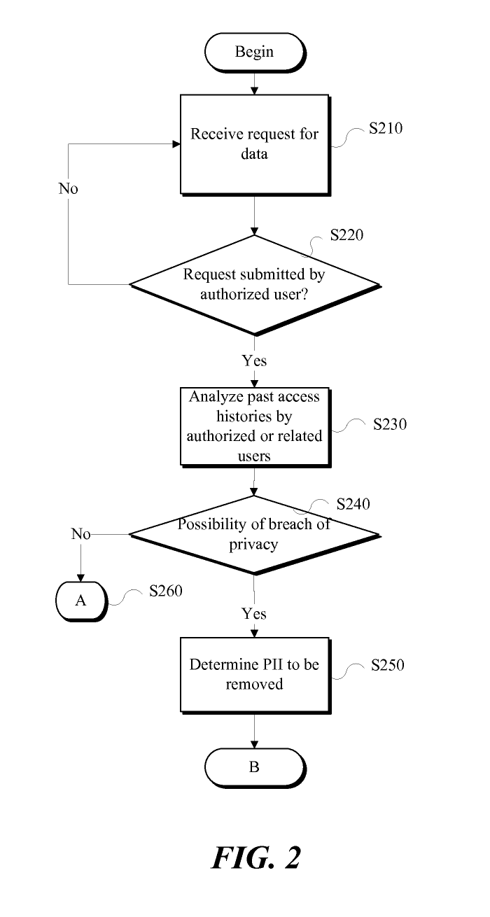

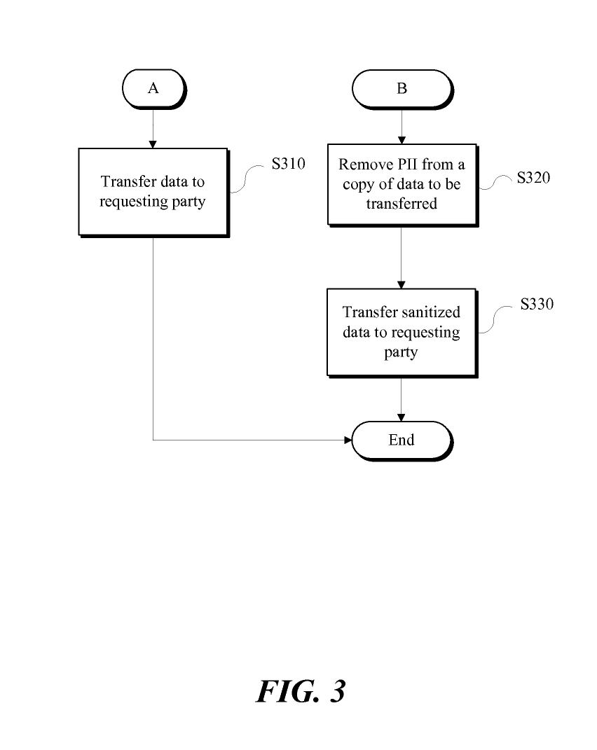

Having the advantage of knowing the prior requests and reports provided to one or more users, any new requests submitted by a user or a related group of users may be scrutinized to limit or further anonymize the provided information to prevent the user from gathering any detailed information other than what the user has authorization to access. Referring to FIGS. 2 and 3, for example, storage system 120 may receive a request for data access from client 110 (S210). The storlet 150, running on storage system 140, may be utilized to determine whether the request is submitted by an authorized user (S220).

If the request is not submitted by an authorized user, then authentication will fail. Otherwise, the past access histories of the authorized users as well as access histories of related users for data store on storage system 120 may be analyzed (S230) to determine the nature and content of private or non-private data previously provided to the user and related users. The analysis of access history may reveal that production of certain data, as requested by the user, may result in breach of privacy (S240). If production of the request data may result in breach of privacy (e.g., there is a possibility that the produced data as cross-referenced with previously produced data may reveal PII), then storlet 150 determines the PII or other relevant data that is to be removed to prevent the breach (S250).

If there is no possibility of breach (S260), then referring to FIG. 3, the data is transferred to the requesting party (S310), with little or no sanitization process being performed. On the other hand, if a risk of breach of privacy is determined as noted earlier, then storlet 150 may be implemented to remove PII from the copy of data that is to be transferred to client 110 (S320), responsive to the pending data request. Once the PII is removed, the data may be deemed sanitized and transferred to the requesting party (S330). The processes associated with analyzing the data requests for permissions and user identity, monitoring the history of past user requests, and sanitizing the data according to the possible risks associated with revealing certain PII may be implemented in a variety of ways.

For example, in one example implementation, a split-key encryption or de-cryption process may be utilized to allow the storlet 150 to read the requested data objects. The storlet 150 may be dynamically configured per data object, for example, with half of the key. A submitted request would contain the other half of the key. When the storlet 150 is executed, the two half keys are combined to allow access to the requested data. It may be assumed that the storlet 150 is trusted and runs in a secure container that cannot be trespassed (e.g., there may be a secure path to transmit the key dynamic configuration data). Accordingly, a best effort solution is provided to prevent a malicious intruder from accessing decrypted data stored on storage system 120.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

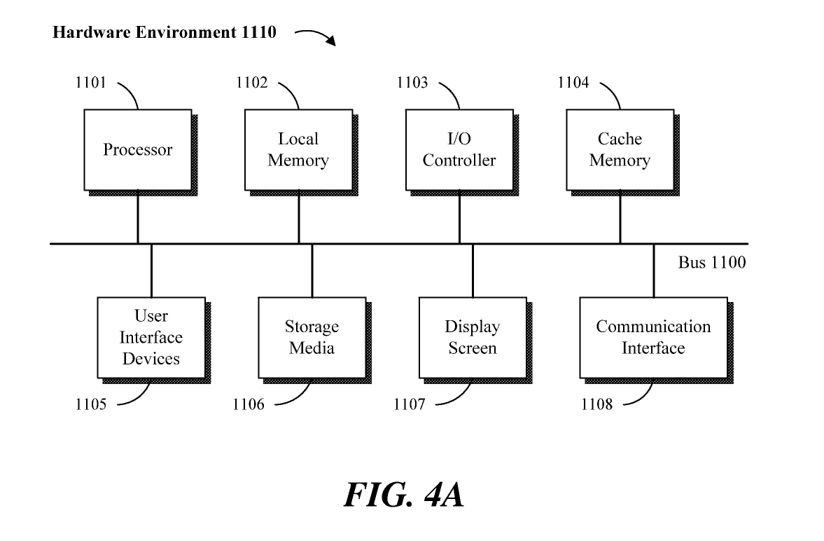

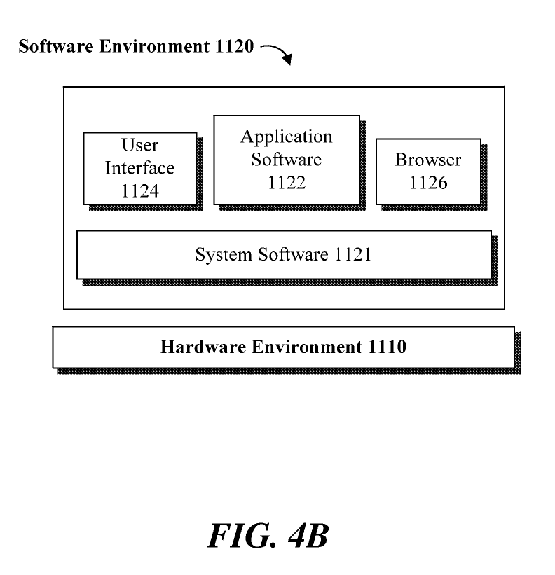

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for sanitizing data, the method comprising:
in response to receiving a data request from a user, determining whether the data request is submitted by an authorized user,
wherein the data request is for accessing first data stored on a data storage system;
in response to determining that the data request is submitted by an authorized user, analyzing data access history by the user to the data storage system;
in response to determining that the user has previously accessed data on the data storage system that in light of the first data reveal confidential information which the user is not authorized to access, restricting user's access to the confidential information.

2. The method of claim 1, wherein restricting user's access to the confidential information comprises removing the confidential information from the first data before transferring the first data to the user.

3. The method of claim 1, wherein restricting user's access to the confidential information comprises including the confidential information in the first data but blocking the confidential information from view before transferring the first data to the user.

4. The method of claim 1, wherein restricting user's access to the confidential information comprises anonymizing the confidential information in the first data before transferring the first data to the user.

5. The method of claim 1, wherein a storlet running on the data storage system performs authentication of the request to determine whether the request is submitted by the authorized user.

6. The method of claim 1, wherein a storlet running on the data storage system performs the data access history analysis to determine whether first data for which the data request is submitted in view of the previously accessed data by the user may reveal confidential information to the user.

7. The method of claim 1, wherein a storlet running on the data storage system restricts user's access to the confidential information by updating content of a copy of the first data that is to be transferred to the user.

8. The method of claim 7, wherein the storlet masks the confidential information in the copy of the first data.

9. The method of claim 7, wherein the storlet deletes the confidential information in the copy of the first data.

10. The method of claim 7, wherein the storlet removes information included in the copy of the first data that if analyzed against data previously accessed by the user would reveal confidential information.

11. A system for sanitizing data, the system comprising:
a logic unit for determining whether a data request is submitted by an authorized user, in response to receiving the data request,
wherein the data request is for accessing first data stored on a data storage system,
wherein in response to determining that the data request is submitted by an authorized user, data access history is analyzed by the user to the data storage system,
wherein in response to determining that the user has previously accessed data on the data storage system that in light of the first data reveal confidential information which the user is not authorized to access, user's access to the confidential information is restricted.

12. The system of claim 11, wherein restricting user's access to the confidential information comprises removing the confidential information from the first data before transferring the first data to the user.

13. The system of claim 11, wherein restricting user's access to the confidential information comprises including the confidential information in the first data but blocking the confidential information from view before transferring the first data to the user.

14. The system of claim 11, wherein restricting user's access to the confidential information comprises anonymizing the confidential information in the first data before transferring the first data to the user.

15. The system of claim 11, wherein a storlet running on the data storage system performs authentication of the request to determine whether the request is submitted by the authorized user.

16. A computer program product comprising a non-transitory computer readable storage medium having a computer readable program, wherein the computer readable program when executed on a computer causes the computer to:
determine whether a data request is submitted by an authorized user, in response to receiving the data request,
wherein the data request is for accessing first data stored on a data storage system,
wherein in response to determining that the data request is submitted by an authorized user, data access history is analyzed by the user to the data storage system,
wherein in response to determining that the user has previously accessed data on the data storage system that in light of the first data reveal confidential information which the user is not authorized to access, user's access to the confidential information is restricted.

17. The computer program product of claim 16, wherein restricting user's access to the confidential information comprises removing the confidential information from the first data before transferring the first data to the user.

18. The computer program product of claim 16, wherein restricting user's access to the confidential information comprises including the confidential information in the first data but blocking the confidential information from view before transferring the first data to the user.

19. The computer program product of claim 16, wherein restricting user's access to the confidential information comprises anonymizing the confidential information in the first data before transferring the first data to the user.

20. The computer program product of claim 16, wherein a storlet running on the data storage system performs authentication of the request to determine whether the request is submitted by the authorized user.
